(19) United States
(12) Patent Application Publication
(10) Pub. No.: US 2022/0246078 A1
(43) Pub. Date: Aug. 4, 2022

(54) IMAGE PROCESSING APPARATUS

(71) Applicant: HIMAX TECHNOLOGIES LIMITED, Tainan City (TW)

(72) Inventor: Chi-Feng CHUANG, Tainan City (TW)

(21) Appl. No.: 17/167,063

(22) Filed: Feb. 3, 2021

(51) Int. Cl. G09G 3/20

(52) U.S. Cl. CPC G09G 3/2003; G09G 3/2074; G09G 2320/0242; G09G 2320/0233; G09G 2300/0452

(57) ABSTRACT

An image processing apparatus includes a receiving unit, a converting unit, a correcting unit, and an inverse converting unit. The receiving unit is configured to receive image data including plural grayscales respectively corresponding to subpixels of a delta RGB panel. The converting unit is configured to convert each of the grayscales into a luminance value corresponding to each of the subpixels. The correcting unit is configured to calculate a corrected luminance value of a target subpixel so as to improve slash jaggy effect and/or color shift effect of the delta RGB panel. The inverse converting unit is configured to convert the corrected luminance value into a corrected grayscale of the target subpixel.

### BACKGROUND

### Field of Invention

The present invention relates to an image processing apparatus. More particularly, the present invention relates to an image processing apparatus of a delta RGB panel.

### Description of Related Art

The delta RGB panel has delta arrangement pixels, in which three sub-pixels constituting one pixel in the delta RGB panel are disposed to define a triangle. Plural pixels in the delta RGB panel are arranged in a matrix throughout the delta RGB panel. However, the sub-pixel arrangement of the delta RGB panel is discontinuous along an oblique direction such that the delta RGB panel has the problem of a slash jaggy effect. Further, the delta RGB panel also has the problem of a color shift effect. For example, when the delta RGB panel displays an image having a white block within a black background, a reddish edge occurs on the left side of the white block and a greenish edge occurs on the right side of the white block.

### SUMMARY

The present invention provides an image processing apparatus including a receiving unit, a converting unit, a correcting unit, and an inverse converting unit. The receiving unit is configured to receive image data including plural grayscales respectively corresponding to subpixels of a delta RGB panel. The delta RGB panel has pixels arranged in rows and columns. Each of the pixels arranged in odd columns has a red subpixel, a green subpixel and a blue subpixel arranged in an inverted triangle. Each of the pixels arranged in even columns has a red subpixel, a green subpixel and a blue subpixel arranged in a regular triangle. The converting unit is configured to convert each of the grayscales into a luminance value corresponding to each of the subpixels. The correcting unit is configured to calculate a corrected luminance value of a target subpixel so as to improve slash jaggy effect of the delta RGB panel. The corrected luminance value of the target subpixel is interpolated based on the luminance value of the target subpixel and the luminance value of an upper subpixel or a lower subpixel having the same color as the target subpixel. The upper subpixel is adjacent to and above the target subpixel and the lower subpixel is adjacent to and below the target subpixel. The inverse converting unit is configured to convert the corrected luminance value into a corrected grayscale of the target subpixel.

In accordance with one or more embodiments of the invention, the red subpixel and the green subpixel are located at an upper side of the inverted triangle. The red subpixel and the green subpixel are located at a lower side of the regular triangle.

In accordance with one or more embodiments of the invention, the corrected luminance value of the target subpixel is interpolated based on the luminance value of the target subpixel and the luminance value of the upper subpixel when the target subpixel is arranged in the odd column and is the red subpixel or the green subpixel or when the target subpixel is arranged in the even column and is the blue subpixel.

In accordance with one or more embodiments of the invention, the corrected luminance value of the target subpixel is interpolated based on the luminance value of the target subpixel and the luminance value of the lower subpixel when the target subpixel is arranged in the even column and is the red subpixel or the green subpixel or when the target subpixel is arranged in the odd column and is the blue subpixel.

In accordance with one or more embodiments of the invention, the corrected luminance value of the target subpixel is interpolated by using a 75% contribution from the luminance value of the target subpixel and a 25% contribution from the luminance value of the upper subpixel when the target subpixel is arranged in the odd column and is the red subpixel or the green subpixel or when the target subpixel is arranged in the even column and is the blue subpixel.

In accordance with one or more embodiments of the invention, the corrected luminance value of the target subpixel is interpolated by using a 75% contribution from the luminance value of the target subpixel and a 25% contribution from the luminance value of the lower subpixel when the target subpixel is arranged in the even column and is the red subpixel or the green subpixel or when the target subpixel is arranged in the odd column and is the blue subpixel.

The present invention further provides an image processing apparatus including a receiving unit, a converting unit, a correcting unit, and an inverse converting unit. The receiving unit is configured to receive image data including plural grayscales respectively corresponding to subpixels of a delta RGB panel. The delta RGB panel has pixels arranged in rows and columns. Each of the pixels arranged in odd columns has a red subpixel, a green subpixel and a blue subpixel arranged in an inverted triangle. Each of the pixels arranged in even columns has a red subpixel, a green subpixel and a blue subpixel arranged in a regular triangle. The converting unit is configured to convert each of the grayscales into a luminance value corresponding to each of the subpixels. The correcting unit is configured to calculate a corrected luminance value of a target subpixel so as to improve color shift effect of the delta RGB panel. The corrected luminance value of the target subpixel is interpolated based on the luminance value of the target subpixel and the luminance value of a left subpixel or a right subpixel having the same color as the target subpixel. The left subpixel is adjacent to and positioned at the left of the target subpixel and the right subpixel is adjacent to and positioned at the right of the target subpixel. The inverse converting unit is configured to convert the corrected luminance value into a corrected grayscale of the target subpixel.

In accordance with one or more embodiments of the invention, the red subpixel and the green subpixel are located at an upper side of the inverted triangle. The red subpixel and the green subpixel are located at a lower side of the regular triangle.

In accordance with one or more embodiments of the invention, the corrected luminance value of the target subpixel is interpolated based on the luminance value of the target subpixel and the luminance value of the left subpixel when the target subpixel is the red subpixel.

In accordance with one or more embodiments of the invention, the corrected luminance value of the target subpixel is interpolated based on the luminance value of the target subpixel and the luminance value of the right subpixel when the target subpixel is the green subpixel.

In accordance with one or more embodiments of the invention, the corrected luminance value of the target subpixel is interpolated by using a 75% contribution from the luminance value of the target subpixel and a 25% contribution from the luminance value of the left subpixel when the target subpixel is the red subpixel.

In accordance with one or more embodiments of the invention, the corrected luminance value of the target subpixel is interpolated by using a 75% contribution from the luminance value of the target subpixel and a 25% contribution from the luminance value of the right subpixel when the target subpixel is the green subpixel.

The present invention further provides an image processing apparatus including a receiving unit, a converting unit, a correcting unit, and an inverse converting unit. The receiving unit is configured to receive image data including plural grayscales respectively corresponding to subpixels of a delta RGB panel. The delta RGB panel has pixels arranged in rows and columns. Each of the pixels arranged in odd columns has a red subpixel, a green subpixel and a blue subpixel arranged in an inverted triangle. Each of the pixels arranged in even columns has a red subpixel, a green subpixel and a blue subpixel arranged in a regular triangle. The converting unit is configured to convert each of the grayscales into a luminance value corresponding to each of the subpixels. The correcting unit is configured to calculate a corrected luminance value of a target subpixel so as to improve slash jaggy effect and color shift effect of the delta RGB panel. The corrected luminance value of the target subpixel is interpolated based on the luminance value of the target subpixel and the luminance value of at least one adjacent subpixel having the same color as the target subpixel. The at least one adjacent subpixel is determined according to a relative position that the target subpixel arranged in odd column is located in the inverted triangle or a relative position that the target subpixel arranged in even column is located in the regular triangle. The inverse converting unit configured to convert the corrected luminance value into a corrected grayscale of the target subpixel.

In accordance with one or more embodiments of the invention, the red subpixel and the green subpixel are located at an upper side of the inverted triangle. The red subpixel and the green subpixel are located at a lower side of the regular triangle.

In accordance with one or more embodiments of the invention, the corrected luminance value of the target subpixel is interpolated based on the luminance value of the target subpixel and the luminance values of an upper subpixel, a left subpixel and an upper left subpixel when the target subpixel is arranged in the odd column and is the red subpixel. The corrected luminance value of the target subpixel is interpolated based on the luminance value of the target subpixel and the luminance values of a lower subpixel, the left subpixel and a lower left subpixel when the target subpixel is arranged in the even column and is the red subpixel. The upper subpixel is adjacent to and above the target subpixel. The lower subpixel is adjacent to and below the target subpixel. The left subpixel is adjacent to and positioned at the left of the target subpixel. The upper left subpixel is adjacent to and positioned at the upper left of the target subpixel. The lower left subpixel is adjacent to and positioned at the lower left of the target subpixel.

In accordance with one or more embodiments of the invention, the corrected luminance value of the target subpixel is interpolated based on the luminance value of the target subpixel and the luminance values of an upper subpixel, a right subpixel and an upper right subpixel when the target subpixel is arranged in the odd column and is the green subpixel. The corrected luminance value of the target subpixel is interpolated based on the luminance value of the target subpixel and the luminance values of a lower subpixel, the right subpixel and a lower right subpixel when the target subpixel is arranged in the even column and is the green subpixel. The upper subpixel is adjacent to and above the target subpixel. The lower subpixel is adjacent to and below the target subpixel. The right subpixel is adjacent to and positioned at the right of the target subpixel. The upper right subpixel is adjacent to and positioned at the upper right of the target subpixel. The lower right subpixel is adjacent to and positioned at the lower right of the target subpixel.

In accordance with one or more embodiments of the invention, the corrected luminance value of the target subpixel is interpolated based on the luminance value of the target subpixel and the luminance value of an upper subpixel or a lower subpixel when the target subpixel is the blue subpixel. The upper subpixel is adjacent to and above the target subpixel. The lower subpixel is adjacent to and below the target subpixel.

In accordance with one or more embodiments of the invention, the corrected luminance value of the target subpixel is interpolated by using a 56.25% contribution from the luminance value of the target subpixel and a 18.75% contribution from the luminance value of the upper subpixel and a 18.75% contribution from the luminance value of the left subpixel and a 6.25% contribution from the luminance value of the upper left subpixel when the target subpixel is arranged in the odd column and is the red subpixel. The corrected luminance value of the target subpixel is interpolated by using a 56.25% contribution from the luminance value of the target subpixel and a 18.75% contribution from the luminance value of the lower subpixel and a 18.75% contribution from the luminance value of the left subpixel and a 6.25% contribution from the luminance value of the lower left subpixel when the target subpixel is arranged in the even column and is the red subpixel.

In accordance with one or more embodiments of the invention, the corrected luminance value of the target subpixel is interpolated by using a 56.25% contribution from the luminance value of the target subpixel and a 18.75% contribution from the luminance value of the upper subpixel and a 18.75% contribution from the luminance value of the right subpixel and a 6.25% contribution from the luminance value of the upper right subpixel when the target subpixel is arranged in the odd column and is the green subpixel. The corrected luminance value of the target subpixel is interpolated by using a 56.25% contribution from the luminance value of the target subpixel and a 18.75% contribution from the luminance value of the lower subpixel and a 18.75% contribution from the luminance value of the right subpixel and a 6.25% contribution from the luminance value of the lower right subpixel when the target subpixel is arranged in the odd column and is the green subpixel.

In accordance with one or more embodiments of the invention, the corrected luminance value of the target subpixel is interpolated by using a 75% contribution from the luminance value of the target subpixel and a 25% contribution from the luminance value of the lower subpixel when the target subpixel is arranged in the odd column and is the blue subpixel. The corrected luminance value of the target subpixel is interpolated by using a 75% contribution from the luminance value of the target subpixel and a 25% contribution from the luminance value of the upper subpixel when the target subpixel is arranged in the even column and is the blue subpixel.

In order to let above mention of the present invention and other objects, features, advantages, and embodiments of the present invention to be more easily understood, the description of the accompanying drawing as follows.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a diagram showing a sub-pixel arrangement of a delta RGB panel according to some embodiments of the present invention.

FIG. 2 illustrates a diagram showing an example showing a problem of a slash jaggy effect occurred on the delta RGB panel.

FIG. 3 illustrates a diagram showing an example showing a problem of a color shift effect occurred on the delta RGB panel.

FIG. 4 illustrates a block diagram of an image processing apparatus according to some embodiments of the present invention.

FIG. 5 illustrates a diagram showing an example showing an operation of the correcting unit when the delta RGB panel displays an image of a red backslash according to a first embodiment of the present invention.

FIG. 6 illustrates a diagram showing an example showing an operation of the correcting unit when the delta RGB panel displays an image having a white block within a black background according to a second embodiment of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. The using of “first”, “second”, “third”, etc. in the specification should be understood for identify units or data described by the same terminology, but are not referred to particular order or sequence.

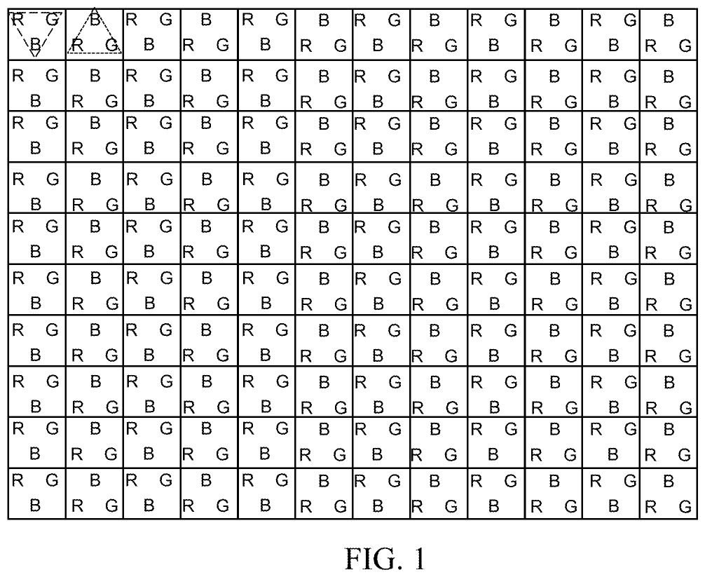

FIG. 1 illustrates a diagram showing a sub-pixel arrangement of a delta RGB panel according to some embodiments of the present invention. As, shown in FIG. 1, the delta RGB panel has pixels arranged in rows and columns. Each of the pixels arranged in odd columns has a red subpixel R, a green subpixel G, and a blue subpixel B arranged in an inverted triangle (see the inverted triangle indicated by broken lines shown in FIG. 1), the red subpixel R and the green subpixel G are located at an upper side of the inverted triangle. Each of the pixels arranged in even columns has a red subpixel R, a green subpixel G, and a blue subpixel B arranged in a regular triangle (see the regular triangle indicated by dotted lines shown in FIG. 1), the red subpixel R and the green subpixel G are located at a lower side of the regular triangle.

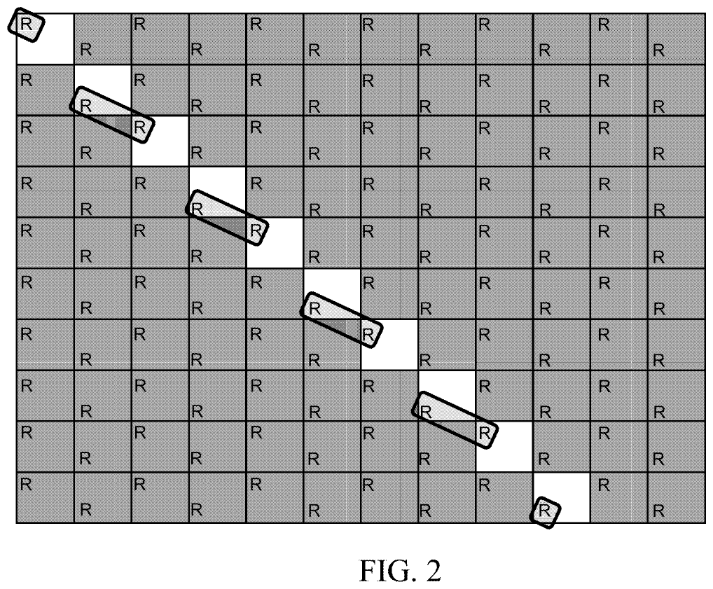

FIG. 2 illustrates a diagram showing an example showing a problem of a slash jaggy effect occurred on the delta RGB panel. As show in FIG. 2, when the delta RGB panel displays an image of a red backslash, the luminance of the red subpixels R corresponding to the red backslash is not continuous because the arrangement of the red subpixels R corresponding to the red backslash is discontinuous such that the delta RGB panel has the problem of the slash jaggy effect. Please note that the arrangement of the green subpixels G is also discontinuous and the arrangement of the blue subpixels B is also discontinuous such that the delta RGB panel has the problem of the slash jaggy effect.

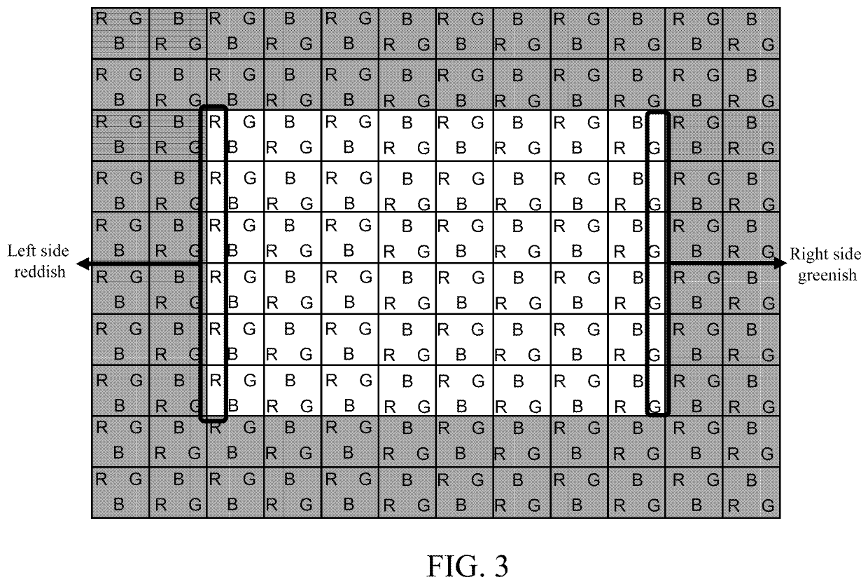

FIG. 3 illustrates a diagram showing an example showing a problem of a color shift effect occurred on the delta RGB panel. As show in FIG. 3, when the delta RGB panel displays an image having a white block within a black background, a reddish edge occurs on the left side of the white block and a greenish edge occurs on the right side of the white block, such that the delta RGB panel has the problem of the color shift effect.

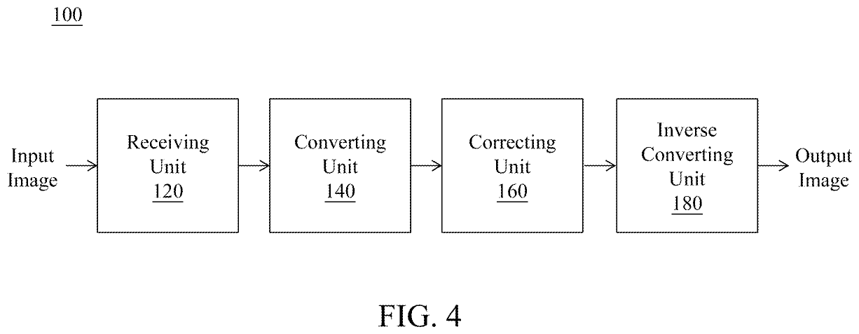

FIG. 4 illustrates a block diagram of an image processing apparatus 100 according to some embodiments of the present invention. The image processing apparatus 100 of the present invention is intended to improve the problem of the slash jaggy effect and/or the problem of the color shift effect of the delta RGB panel.

The image processing apparatus 100 includes a receiving unit 120, a converting unit 140 coupled to the receiving unit 120, a correcting unit 160 coupled to the converting unit 140, and an inverse converting unit 180 coupled to the correcting unit 160. The receiving unit 120 is configured to receive image data of an input image, in which the image data includes plural grayscales respectively corresponding to plural subpixels of the delta RGB panel. The converting unit 140 is configured to convert each of the grayscales into a luminance value corresponding to each of the subpixels. The correcting unit 160 is configured to calculate a corrected luminance value of a target subpixel. The inverse converting unit 180 is configured to convert the corrected luminance value into a corrected grayscale of the target subpixel such that the inverse converting unit 180 output image data of an output image to the delta RGB panel, thereby improving the problem of the slash jaggy effect and/or the problem of the color shift effect of the delta RGB panel.

In a first embodiment of the present invention, the correcting unit 160 is configured to calculate a corrected luminance value of a target subpixel so as to improve the problem of the slash jaggy effect of the delta RGB panel. In the first embodiment of the present invention, the corrected luminance value of the target subpixel is interpolated based on the luminance value of the target subpixel and the luminance value of the upper subpixel when the target subpixel is arranged in the odd column and is the red subpixel R or the green subpixel G or when the target subpixel is arranged in the even column and is the blue subpixel B, and the corrected luminance value of the target subpixel is interpolated based on the luminance value of the target subpixel and the luminance value of the lower subpixel when the target subpixel is arranged in the even column and is the red subpixel R or the green subpixel G or when the target subpixel is arranged in the odd column and is the blue subpixel B. Both of the upper subpixel and the lower subpixel have the same color as the target subpixel. The upper subpixel is adjacent to and above the target subpixel and the lower subpixel is adjacent to and below the target subpixel.

Specifically, in the first embodiment of the present invention, the correcting unit 160 is configured to use a 3*3 filter as a deJaggy filter mask applied on the target subpixel, and the said deJaggy filter mask is

$$[ \begin{matrix}0 & 1 \text{/} 4 & 0 \\ 0 & 3 \text{/} 4 & 0 \\ 0 & 0 & 0\end{matrix} ]$$

when the target subpixel is arranged in the odd column and is the red subpixel R or the green subpixel G or when the target subpixel is arranged in the even column and is the blue subpixel B, and the said deJaggy filter mask is

$$[ \begin{matrix}0 & 0 & 0 \\ 0 & 3 \text{/} 4 & 0 \\ 0 & 1 \text{/} 4 & 0\end{matrix} ]$$

when the target subpixel is arranged in the even column and is the red subpixel R or the green subpixel G or when the target subpixel is arranged in the odd column and is the blue subpixel B.

Thus, in the first embodiment of the present invention, the corrected luminance value of the target subpixel is interpolated by using a 75% (¾) contribution from the luminance value of the target subpixel and a 25% (¼) contribution from the luminance value of the upper subpixel when the target subpixel is arranged in the odd column and is the red subpixel R or the green subpixel G or when the target subpixel is arranged in the even column and is the blue subpixel B, and the corrected luminance value of the target subpixel is interpolated by using a 75% (¾) contribution from the luminance value of the target subpixel and a 25% (¼) contribution from the luminance value of the lower subpixel when the target subpixel is arranged in the even column and is the red subpixel R or the green subpixel G or when the target subpixel is arranged in the odd column and is the blue subpixel B.

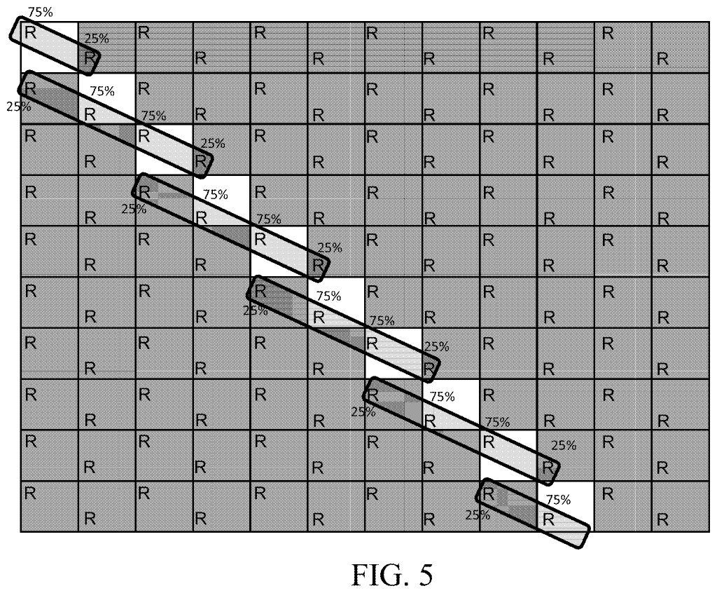

FIG. 5 illustrates a diagram showing an example showing an operation of the correcting unit 160 when the delta RGB panel displays an image of a red backslash according to the first embodiment of the present invention. For example, when the target subpixel is the red subpixel R arranged at the second column and the second row, the target subpixel is located on the red backslash and the lower subpixel is located on the black background, and therefore the corrected luminance value of the target subpixel is identical to 75% contribution from the luminance value of the target subpixel. For example, when the target subpixel is the red subpixel R arranged at the first column and the second row, the target subpixel is located on the black background and the upper subpixel is located on the red backslash, and therefore the corrected luminance value of the target subpixel is identical to 25% contribution from the luminance value of the upper subpixel. Therefore, as shown in FIG. 5, after applying the deJaggy filter mask, the arrangement of the corrected luminance values of the red subpixels R corresponding to the red backslash is smoother, thereby improving the problem of the slash jaggy effect of the delta RGB panel.

In a second embodiment of the present invention, the correcting unit 160 is configured to calculate a corrected luminance value of a target subpixel so as to improve the problem of the color shift effect of the delta RGB panel. In the second embodiment of the present invention, the corrected luminance value of the target subpixel is interpolated based on the luminance value of the target subpixel and the luminance value of the left subpixel when the target subpixel is the red subpixel R, and the corrected luminance value of the target subpixel is interpolated based on the luminance value of the target subpixel and the luminance value of the right subpixel when the target subpixel is the green subpixel G. Both of the left subpixel and the right subpixel have the same color as the target subpixel. The left subpixel is adjacent to and positioned at the left of the target subpixel and the right subpixel is adjacent to and positioned at the right of the target subpixel.

Specifically, in the second embodiment of the present invention, the correcting unit 160 is configured to use a 3*3 filter as a deColorShift filter mask applied on the target subpixel, and the said deColorShift filter mask is

$$[ \begin{matrix}0 & 0 & 0 \\ 1 \text{/} 4 & 3 \text{/} 4 & 0 \\ 0 & 0 & 0\end{matrix} ]$$

when the target subpixel is the red subpixel R, and the said deColorShift filter mask is

$$[ \begin{matrix}0 & 0 & 0 \\ 0 & 3 \text{/} 4 & 1 \text{/} 4 \\ 0 & 0 & 0\end{matrix} ]$$

when the target subpixel is the green subpixel G.

Thus, in the second embodiment of the present invention, the corrected luminance value of the target subpixel is interpolated by using a 75% (¾) contribution from the luminance value of the target subpixel and a 25% (¼) contribution from the luminance value of the left subpixel when the target subpixel is the red subpixel R, and the corrected luminance value of the target subpixel is interpolated by using a 75% (¾) contribution from the luminance value of the target subpixel and a 25% (¼) contribution from the luminance value of the right subpixel when the target subpixel is the green subpixel G.

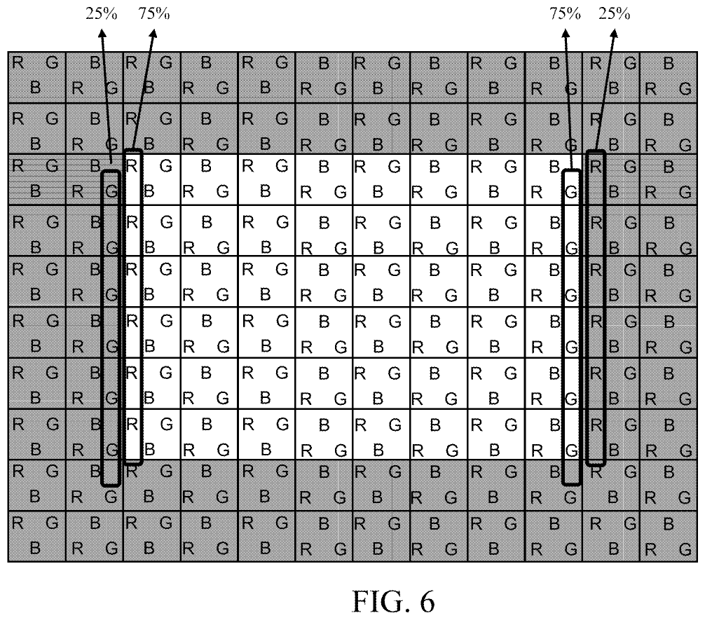

FIG. 6 illustrates a diagram showing an example showing an operation of the correcting unit 160 when the delta RGB panel displays an image having a white block within a black background according to the second embodiment of the present invention. For example, when the target subpixel is the red subpixel R arranged at the first column of the left edge of the white block, the target subpixel is located on the white block and the left subpixel is located on the black background, and therefore the corrected luminance value of the target subpixel is identical to 75% contribution from the luminance value of the target subpixel. For example, when the target subpixel is the green subpixel G arranged at the column left adjacent to the left edge of the white block, the target subpixel is located on the black background and the right subpixel is located on the white block, and therefore the corrected luminance value of the target subpixel is identical to 25% contribution from the luminance value of the right subpixel. Therefore, as shown in FIG. 6, after applying the deColorShift filter mask, the left edge of the white block has a reduced luminance of the red subpixel R and an increased luminance of the green subpixel G such that the reddish is mitigated, and the right edge of the white block has a reduced luminance of the green subpixel G and an increased luminance of the red subpixel R such that the greenish is mitigated, thereby improving the problem of the color shift effect of the delta RGB panel.

In a third embodiment of the present invention, the correcting unit 160 is configured to calculate a corrected luminance value of a target subpixel so as to improve the problem of the slash jaggy effect and the color shift effect of the delta RGB panel. In the third embodiment of the present invention, the corrected luminance value of the target subpixel is interpolated based on the luminance value of the target subpixel and the luminance value of at least one adjacent subpixel having the same color as the target subpixel. When the target subpixel arranged in odd column, the said at least one adjacent subpixel is determined according to a relative position that the target subpixel is located in the inverted triangle. When the target subpixel arranged in even column, the said at least one adjacent subpixel is determined according to a relative position that the target subpixel is located in the regular triangle.

Specifically, in the third embodiment of the present invention, the correcting unit 160 is configured to use a 3*3 filter as a final filter mask applied on the target subpixel. Please note that the final filter is obtained by convoluting the deJaggy filter mask with the deColorShift filter mask. Therefore, the said final filter mask is

$$[ \begin{matrix}1 / 16 & 3 \text{/} 16 & 0 \\ 3 \text{/} 16 & 9 \text{/} 16 & 0 \\ 0 & 0 & 0\end{matrix} ]$$

when the target subpixel is arranged in the odd column and is the red subpixel R, and the said final filter mask is

$$[ \begin{matrix}0 & 0 & 0 \\ 3 \text{/} 16 & 9 \text{/} 16 & 0 \\ 1 \text{/} 16 & 3 \text{/} 16 & 0\end{matrix} ]$$

when the target subpixel is arranged in the even column and is the red subpixel R, and the said final filter mask is

$$[ \begin{matrix}0 & 3 \text{/} 16 & 1 \text{/} 16 \\ 0 & 9 \text{/} 16 & 3 \text{/} 16 \\ 0 & 0 & 0\end{matrix} ]$$

when the target subpixel is arranged in the odd column and is the green subpixel G, and the said final filter mask is

$$[ \begin{matrix}0 & 0 & 0 \\ 0 & 9 \text{/} 16 & 3 \text{/} 16 \\ 0 & 3 \text{/} 16 & 1 \text{/} 16\end{matrix} ]$$

when the target subpixel is arranged in the even column and is the green subpixel G, and the said final filter mask is

$$[ \begin{matrix}0 & 0 & 0 \\ 0 & 3 \text{/} 4 & 0 \\ 0 & 1 \text{/} 4 & 0\end{matrix} ]$$

when the target subpixel is arranged in the odd column and is the blue subpixel B, and the said final filter mask is

$$[ \begin{matrix}0 & 1 \text{/} 4 & 0 \\ 0 & 3 \text{/} 4 & 0 \\ 0 & 0 & 0\end{matrix} ]$$

when the target subpixel is arranged in the even column and is the blue subpixel B.

Thus, in the third embodiment of the present invention, the corrected luminance value of the target subpixel is interpolated by using a 56.25% ( 9/16) contribution from the luminance value of the target subpixel and a 18.75% ( 3/16) contribution from the luminance value of the upper subpixel and a 18.75% ( 3/16) contribution from the luminance value of the left subpixel and a 6.25% ( 1/16) contribution from the luminance value of the upper left subpixel when the target subpixel is arranged in the odd column and is the red subpixel R. In detail, when the target subpixel is arranged in the odd column and is the red subpixel R, a relative position that the said target subpixel (i.e., the red subpixel R arranged in the odd column) is located in the inverted triangle is closer to the upper left side of the inverted triangle, as shown in FIG. 1, and therefore the said at least one adjacent subpixel is determined as the upper subpixel, the left subpixel, and the upper left subpixel. Further, in the third embodiment of the present invention, the corrected luminance value of the target subpixel is interpolated by using a 56.25% ( 9/16) contribution from the luminance value of the target subpixel and a 18.75% ( 3/16) contribution from the luminance value of the lower subpixel and a 18.75% ( 3/16) contribution from the luminance value of the left subpixel and a 6.25% ( 1/16) contribution from the luminance value of the lower left subpixel when the target subpixel is arranged in the even column and is the red subpixel R. In detail, when the target subpixel is arranged in the even column and is the red subpixel R, a relative position that the said target subpixel (i.e., the red subpixel R arranged in the even column) is located in the regular triangle is closer to the lower left side of the regular triangle, as shown in FIG. 1, and therefore the said at least one adjacent subpixel is determined as the lower subpixel, the left subpixel, and the lower left subpixel. The upper subpixel, the lower subpixel, the left subpixel, the upper left subpixel, and the lower left subpixel have the same color as the target subpixel. The upper subpixel is adjacent to and above the target subpixel. The lower subpixel is adjacent to and below the target subpixel. The left subpixel is adjacent to and positioned at the left of the target subpixel. The upper left subpixel is adjacent to and positioned at the upper left of the target subpixel. The lower left subpixel is adjacent to and positioned at the lower left of the target subpixel.

Further, in the third embodiment of the present invention, the corrected luminance value of the target subpixel is interpolated by using a 56.25% ( 9/16) contribution from the luminance value of the target subpixel and a 18.75% ( 3/16) contribution from the luminance value of the upper subpixel and a 18.75% ( 3/16) contribution from the luminance value of the right subpixel and a 6.25% ( 1/16) contribution from the luminance value of the upper right subpixel when the target subpixel is arranged in the odd column and is the green subpixel G. In detail, when the target subpixel is arranged in the odd column and is the green subpixel G, a relative position that the said target subpixel (i.e., the green subpixel G arranged in the odd column) is located in the inverted triangle is closer to the upper right side of the inverted triangle, as shown in FIG. 1, and therefore the said at least one adjacent subpixel is determined as the upper subpixel, the right subpixel, and the upper right subpixel. Further, in the third embodiment of the present invention, the corrected luminance value of the target subpixel is interpolated by using a 56.25% ( 9/16) contribution from the luminance value of the target subpixel and a 18.75% ( 3/16) contribution from the luminance value of the lower subpixel and a 18.75% ( 3/16) contribution from the luminance value of the right subpixel and a 6.25% ( 1/16) contribution from the luminance value of the lower right subpixel when the target subpixel is arranged in the odd column and is the green subpixel G. The upper subpixel, the lower subpixel, the right subpixel, the upper right subpixel, and the lower right subpixel have the same color as the target subpixel. In detail, when the target subpixel is arranged in the even column and is the red subpixel R, a relative position that the said target subpixel (i.e., the red subpixel R arranged in the even column) is located in the regular triangle is closer to the lower left side of the regular triangle, as shown in FIG. 1, and therefore the said at least one adjacent subpixel is determined as the lower subpixel, the left subpixel, and the lower left subpixel. The upper subpixel, the lower subpixel, the right subpixel, the upper right subpixel, and the lower right subpixel have the same color as the target subpixel. The upper subpixel is adjacent to and above the target subpixel. The lower subpixel is adjacent to and below the target subpixel. The right subpixel is adjacent to and positioned at the right of the target subpixel. The upper right subpixel is adjacent to and positioned at the upper right of the target subpixel. The lower right subpixel is adjacent to and positioned at the lower right of the target subpixel.

In addition, in the third embodiment of the present invention, the corrected luminance value of the target subpixel is interpolated by using a 75% (¾) contribution from the luminance value of the target subpixel and a 25% (¼) contribution from the luminance value of the lower subpixel when the target subpixel is arranged in the odd column and is the blue subpixel B. In detail, when the target subpixel is arranged in the odd column and is the blue subpixel B, a relative position that the said target subpixel (i.e., the blue subpixel B arranged in the odd column) is located in the inverted triangle is closer to the lower side of the inverted triangle, as shown in FIG. 1, and therefore the said at least one adjacent subpixel is determined as the lower subpixel. Further, in the third embodiment of the present invention, the corrected luminance value of the target subpixel is interpolated by using a 75% (¾) contribution from the luminance value of the target subpixel and a 25% (¼) contribution from the luminance value of the upper subpixel when the target subpixel is arranged in the even column and is the blue subpixel B. In detail, when the target subpixel is arranged in the even column and is the blue subpixel B, a relative position that the said target subpixel (i.e., the blue subpixel B arranged in the even column) is located in the regular triangle is closer to the upper left side of the regular triangle, as shown in FIG. 1, and therefore the said at least one adjacent subpixel is determined as the upper subpixel. The upper subpixel and the lower subpixel have the same color as the target subpixel. The upper subpixel is adjacent to and above the target subpixel. The lower subpixel is adjacent to and below the target subpixel.

Therefore, after applying the final filter mask, the problem of the slash jaggy effect and the color shift effect of the delta RGB panel could be improved.

From the above description, the present invention provides an image processing apparatus of a delta RGB panel so as to improve the slash jaggy effect and the color shift effect of the delta RGB panel.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An image processing apparatus, comprising:
a receiving unit configured to receive image data including a plurality of grayscales respectively corresponding to subpixels of a delta RGB panel, wherein the delta RGB panel has pixels arranged in rows and columns, wherein each of the pixels arranged in odd columns has a red subpixel, a green subpixel and a blue subpixel arranged in an inverted triangle, wherein each of the pixels arranged in even columns has a red subpixel, a green subpixel and a blue subpixel arranged in a regular triangle;
a converting unit configured to convert each of the grayscales into a luminance value corresponding to each of the subpixels;
a correcting unit configured to calculate a corrected luminance value of a target subpixel so as to improve slash jaggy effect of the delta RGB panel, wherein the corrected luminance value of the target subpixel is interpolated based on the luminance value of the target subpixel and the luminance value of an upper subpixel or a lower subpixel having the same color as the target subpixel, wherein the upper subpixel is adjacent to and above the target subpixel and the lower subpixel is adjacent to and below the target subpixel; and
an inverse converting unit configured to convert the corrected luminance value into a corrected grayscale of the target subpixel.

2. The image processing apparatus of claim 1, wherein the red subpixel and the green subpixel are located at an upper side of the inverted triangle, wherein the red subpixel and the green subpixel are located at a lower side of the regular triangle.

3. The image processing apparatus of claim 1, wherein the corrected luminance value of the target subpixel is interpolated based on the luminance value of the target subpixel and the luminance value of the upper subpixel when the target subpixel is arranged in the odd column and is the red subpixel or the green subpixel or when the target subpixel is arranged in the even column and is the blue subpixel.

4. The image processing apparatus of claim 1, wherein the corrected luminance value of the target subpixel is interpolated based on the luminance value of the target subpixel and the luminance value of the lower subpixel when the target subpixel is arranged in the even column and is the red subpixel or the green subpixel or when the target subpixel is arranged in the odd column and is the blue subpixel.

5. The image processing apparatus of claim 3, wherein the corrected luminance value of the target subpixel is interpolated by using a 75% contribution from the luminance value of the target subpixel and a 25% contribution from the luminance value of the upper subpixel when the target subpixel is arranged in the odd column and is the red subpixel or the green subpixel or when the target subpixel is arranged in the even column and is the blue subpixel.

6. The image processing apparatus of claim 4, wherein the corrected luminance value of the target subpixel is interpolated by using a 75% contribution from the luminance value of the target subpixel and a 25% contribution from the luminance value of the lower subpixel when the target subpixel is arranged in the even column and is the red subpixel or the green subpixel or when the target subpixel is arranged in the odd column and is the blue subpixel.

7. An image processing apparatus, comprising:
a receiving unit configured to receive image data including a plurality of grayscales respectively corresponding to subpixels of a delta RGB panel, wherein the delta RGB panel has pixels arranged in rows and columns, wherein each of the pixels arranged in odd columns has a red subpixel, a green subpixel and a blue subpixel arranged in an inverted triangle, wherein each of the pixels arranged in even columns has a red subpixel, a green subpixel and a blue subpixel arranged in a regular triangle;
a converting unit configured to convert each of the grayscales into a luminance value corresponding to each of the subpixels;
a correcting unit configured to calculate a corrected luminance value of a target subpixel so as to improve color shift effect of the delta RGB panel, wherein the corrected luminance value of the target subpixel is interpolated based on the luminance value of the target subpixel and the luminance value of a left subpixel or a right subpixel having the same color as the target subpixel, wherein the left subpixel is adjacent to and positioned at the left of the target subpixel and the right subpixel is adjacent to and positioned at the right of the target subpixel; and
an inverse converting unit configured to convert the corrected luminance value into a corrected grayscale of the target subpixel.

8. The image processing apparatus of claim 7, wherein the red subpixel and the green subpixel are located at an upper side of the inverted triangle, wherein the red subpixel and the green subpixel are located at a lower side of the regular triangle.

9. The image processing apparatus of claim 7, wherein the corrected luminance value of the target subpixel is interpolated based on the luminance value of the target subpixel and the luminance value of the left subpixel when the target subpixel is the red subpixel.

10. The image processing apparatus of claim 7, wherein the corrected luminance value of the target subpixel is interpolated based on the luminance value of the target subpixel and the luminance value of the right subpixel when the target subpixel is the green subpixel.

11. The image processing apparatus of claim 9, wherein the corrected luminance value of the target subpixel is interpolated by using a 75% contribution from the luminance value of the target subpixel and a 25% contribution from the luminance value of the left subpixel when the target subpixel is the red subpixel.

12. The image processing apparatus of claim 10, wherein the corrected luminance value of the target subpixel is interpolated by using a 75% contribution from the luminance value of the target subpixel and a 25% contribution from the luminance value of the right subpixel when the target subpixel is the green subpixel.

13. An image processing apparatus, comprising:
a receiving unit configured to receive image data including a plurality of grayscales respectively corresponding to subpixels of a delta RGB panel, wherein the delta RGB panel has pixels arranged in rows and columns, wherein each of the pixels arranged in odd columns has a red subpixel, a green subpixel and a blue subpixel arranged in an inverted triangle, wherein each of the pixels arranged in even columns has a red subpixel, a green subpixel and a blue subpixel arranged in a regular triangle;
a converting unit configured to convert each of the grayscales into a luminance value corresponding to each of the subpixels;
a correcting unit configured to calculate a corrected luminance value of a target subpixel so as to improve slash jaggy effect and color shift effect of the delta RGB panel, wherein the corrected luminance value of the target subpixel is interpolated based on the luminance value of the target subpixel and the luminance value of at least one adjacent subpixel having the same color as the target subpixel, wherein the at least one adjacent subpixel is determined according to a relative position that the target subpixel arranged in odd column is located in the inverted triangle or a relative position that the target subpixel arranged in even column is located in the regular triangle; and
an inverse converting unit configured to convert the corrected luminance value into a corrected grayscale of the target subpixel.

14. The image processing apparatus of claim 13, wherein the red subpixel and the green subpixel are located at an upper side of the inverted triangle, wherein the red subpixel and the green subpixel are located at a lower side of the regular triangle.

15. The image processing apparatus of claim 13,
wherein the corrected luminance value of the target subpixel is interpolated based on the luminance value of the target subpixel and the luminance values of an upper subpixel, a left subpixel and an upper left subpixel when the target subpixel is arranged in the odd column and is the red subpixel;
wherein the corrected luminance value of the target subpixel is interpolated based on the luminance value of the target subpixel and the luminance values of a lower subpixel, the left subpixel and a lower left subpixel when the target subpixel is arranged in the even column and is the red subpixel;
wherein the upper subpixel is adjacent to and above the target subpixel, wherein the lower subpixel is adjacent to and below the target subpixel, wherein the left subpixel is adjacent to and positioned at the left of the target subpixel, wherein the upper left subpixel is adjacent to and positioned at the upper left of the target subpixel, wherein the lower left subpixel is adjacent to and positioned at the lower left of the target subpixel.

16. The image processing apparatus of claim 13,
wherein the corrected luminance value of the target subpixel is interpolated based on the luminance value of the target subpixel and the luminance values of an upper subpixel, a right subpixel and an upper right subpixel when the target subpixel is arranged in the odd column and is the green subpixel;
wherein the corrected luminance value of the target subpixel is interpolated based on the luminance value of the target subpixel and the luminance values of a lower subpixel, the right subpixel and a lower right subpixel when the target subpixel is arranged in the even column and is the green subpixel;
wherein the upper subpixel is adjacent to and above the target subpixel, wherein the lower subpixel is adjacent to and below the target subpixel, wherein the right subpixel is adjacent to and positioned at the right of the target subpixel, wherein the upper right subpixel is adjacent to and positioned at the upper right of the target subpixel, wherein the lower right subpixel is adjacent to and positioned at the lower right of the target subpixel.

17. The image processing apparatus of claim 13,
wherein the corrected luminance value of the target subpixel is interpolated based on the luminance value of the target subpixel and the luminance value of an upper subpixel or a lower subpixel when the target subpixel is the blue subpixel;
wherein the upper subpixel is adjacent to and above the target subpixel, wherein the lower subpixel is adjacent to and below the target subpixel.

18. The image processing apparatus of claim 15,
wherein the corrected luminance value of the target subpixel is interpolated by using a 56.25% contribution from the luminance value of the target subpixel and a 18.75% contribution from the luminance value of the upper subpixel and a 18.75% contribution from the luminance value of the left subpixel and a 6.25% contribution from the luminance value of the upper left subpixel when the target subpixel is arranged in the odd column and is the red subpixel;
wherein the corrected luminance value of the target subpixel is interpolated by using a 56.25% contribution from the luminance value of the target subpixel and a 18.75% contribution from the luminance value of the lower subpixel and a 18.75% contribution from the luminance value of the left subpixel and a 6.25% contribution from the luminance value of the lower left subpixel when the target subpixel is arranged in the even column and is the red subpixel.

19. The image processing apparatus of claim 16,
wherein the corrected luminance value of the target subpixel is interpolated by using a 56.25% contribution from the luminance value of the target subpixel and a 18.75% contribution from the luminance value of the upper subpixel and a 18.75% contribution from the luminance value of the right subpixel and a 6.25% contribution from the luminance value of the upper right subpixel when the target subpixel is arranged in the odd column and is the green subpixel;
wherein the corrected luminance value of the target subpixel is interpolated by using a 56.25% contribution from the luminance value of the target subpixel and a 18.75% contribution from the luminance value of the lower subpixel and a 18.75% contribution from the luminance value of the right subpixel and a 6.25% contribution from the luminance value of the lower right subpixel when the target subpixel is arranged in the odd column and is the green subpixel.

20. The image processing apparatus of claim 17,
wherein the corrected luminance value of the target subpixel is interpolated by using a 75% contribution from the luminance value of the target subpixel and a 25% contribution from the luminance value of the lower subpixel when the target subpixel is arranged in the odd column and is the blue subpixel;
wherein the corrected luminance value of the target subpixel is interpolated by using a 75% contribution from the luminance value of the target subpixel and a 25% contribution from the luminance value of the upper subpixel when the target subpixel is arranged in the even column and is the blue subpixel.
